(19) United States
(12) Patent Application Publication
(10) Pub. No.: US 2015/0247813 A1
(43) Pub. Date: Sep. 3, 2015

(54) Method for determining the concentration of a substance in a sample

(71) Applicant: Bruker BioSpin GmbH, Rheinstetten (DE)

(72) Inventor: Christian Fischer, Rheinstetten (DE)

(21) Appl. No.: 14/625,667

(22) Filed: Feb. 19, 2015

(30) Foreign Application Priority Data
Feb. 28, 2014 (DE) 10 2014 203 721.2

(51) Int. Cl. G01N 24/08; G01N 21/27

(52) U.S. Cl. CPC G01N 24/08; G01N 21/27; G01N 2201/12

(57) ABSTRACT

A method for determining the concentration of a substance in a sample (91) calculates a plurality of intermediate spectra (ZW1, ZW2) from a measured reference spectrum (RS) of the substance. For calculating the intermediate spectra (ZW1, ZW2), the following individual steps are applied to the reference spectrum (RS): shifting the position in accordance with a shift parameter; multiplication with an amplitude factor; and convolution with a system function in accordance with a line broadening parameter. The shift parameter, the amplitude factor and the line broadening parameter are changed within the scope of an optimization algorithm that iteratively optimizes the correspondence between the intermediate spectra (ZW1, ZW2) and the measured spectrum (GS). A simplified method for determining the concentration of a substance in a sample is thereby provided with which the involvement of an expert in spectral analysis is not necessarily required.

This application claims Paris convention priority from DE 10 2014 203 721.2 filed Feb. 28, 2014, the entire disclosure of which is hereby incorporated by reference.

### BACKGROUND OF THE INVENTION

The invention concerns a method for determining the concentration of a substance in a sample, in particular a liquid sample, wherein a signal portion that can be attributed to the substance is determined in a measured sample spectrum that gives an intensity as a function of a position.

One frequent quality control task in numerous industrial processes or also in research and medical diagnostics is the quantitative examination of the composition of a sample that has been taken, in particular, the determination of the concentration of a specific substance in the sample. In order to determine the concentration of a substance in a sample, the substance contained in the sample can be quantitatively converted with a reagent, e.g. until the color change of an added indicator indicates the end of the conversion reaction, wherein the amount of the added reagent is observed. However, these conventional chemical methods are relatively complex and have been largely replaced by spectroscopic methods in the recent past. Spectroscopic methods utilize the interaction between the substance in the sample and an investigating radiation to determine the concentration.

NMR (nuclear magnetic resonance) spectroscopy is a powerful spectroscopic method of quantitative analytical chemistry. In one-dimensional NMR spectroscopy, the nuclear spins contained in the sample are thereby typically oriented in a strong static magnetic field and the nuclear magnetization is rotated through 90° by means of a radio frequency pulse. The radio frequency response of the sample is subsequently recorded as a function of time (FID signal, FID=free induction decay). A frequency spectrum of the sample can be obtained from the time signal by means of Fourier transformation, the frequency spectrum containing characteristic peaks for the individual components of the sample, wherein the individual peaks of the components are superimposed to a greater or lesser extent.

The intensity of the peaks of the individual components of the sample is basically proportional to the concentration of the associated component in the sample. However, due to superimposition of a plurality of peaks in a spectrum, it is often difficult to quantitatively determine the signal portion that belongs to a certain substance. This applies not only to NMR but also to other spectroscopic methods such as IR (infrared) spectroscopy or X-ray spectroscopy (X-ray fluorescence or X-ray absorption).

The relative position and relative intensity of the peaks of a substance can be determined in NMR spectroscopy in a so-called quantum-mechanical approach by means of the chemical structure and a measured reference spectrum of the substance to be determined. In this connection, in particular, chemical shifts and coupling constants are derived from the measured reference spectrum of the sample. This requires an expert in spectral analyses. The peaks determined in this fashion are then adjusted by an overall frequency shift and an overall amplitude change and, if necessary, by changing the quantum-mechanical calculation, in particular, varying the coupling constants until a sufficient correlation with a measured spectrum of the sample is obtained. This may be followed by integration under the adjusted peaks for determining the signal portion of the substance. The quantum-mechanical approach is implemented e.g. in the spectral analysis software “TopSpin” in the software module “DAISY” of Bruker BioSpin GmbH, Rheinstetten, Germany.

Another conventional method consists in identifying, in a reference spectrum of the substance to be determined, the individual peaks that belong to the substance and determining the relative positions, intensities, line widths and line shapes. This requires, in turn, an expert in spectral analysis. This may be followed by fitting the peaks to the measured spectrum of the sample and then be followed again by integration under the fitted peaks for determining the signal portion of the substance. This so-called multiplet approach is implemented e.g. in the spectral analysis software “Chenomx NMR Suite” of Chenomx Inc., Edmonton, Alberta, Canada.

Both these approaches require an expert in spectral analysis at least for evaluating the reference spectrum of the substance to be determined. The evaluations of the expert are time-consuming and expensive or limit the quantitative analysis of substances for which an evaluation of a reference spectrum does not yet exist.

US 2004/0058386 A1 discloses describing the peaks contained in an NMR reference spectrum using a Lorentz function, wherein peaks in the same cluster are allocated uniform peak widths. Clusters can be frequency-shifted for adjustment to a measured NMR test spectrum of a sample. Upper concentration limits for a component are subsequently determined via the peak heights in the reference spectrum and in the measured spectrum.

It is the underlying purpose of the invention to provide a simplified method for determining the concentration of a substance in a sample, in particular, wherein the method does not require the involvement of an expert in spectral analysis.

### SUMMARY OF THE INVENTION

This object is achieved by a method for determining the concentration of a substance in a sample, in particular, a liquid sample, wherein a signal portion that can be attributed to the substance is determined in a measured sample spectrum that gives an intensity as a function of a position, wherein a plurality of intermediate spectra is calculated in each case from a measured reference spectrum of the substance until a predetermined correlation between a resulting intermediate spectrum and the measured spectrum is obtained, and wherein the signal portion is calculated through integration of the resulting intermediate spectrum fitted to the measured spectrum, wherein for calculating the intermediate spectra the following individual steps are applied to the reference spectrum:

a) shifting the position in accordance with a shift parameter;
b) multiplication with an amplitude factor;
c) convolution with a system function in accordance with a line broadening parameter, wherein the shift parameter, the amplitude factor and the line broadening parameter are changed within the scope of an optimization algorithm that iteratively optimizes the correspondence between the intermediate spectra and the measured spectrum.

For determining the concentration, the present invention directly utilizes a reference spectrum of the substance to be quantitatively determined in the sample. The reference spectrum typically has three or more peaks that can be attributed to the substance and typically subtends a substantially smaller position range (in NMR: frequency range) than the measured spectrum of the sample, i.e. without identification of individual peaks in the reference spectrum.

The reference spectrum is converted into an intermediate spectrum through three individual steps that are each applied in one iteration stage, wherein the intermediate spectrum is compared with the measured (experimental) spectrum of the sample for correspondence. Each iteration stage of the optimization algorithm thus includes new determination of an intermediate spectrum from the reference spectrum. The optimization algorithm typically calculates a correlation function (deviation function) for each intermediate spectrum with respect to the measured spectrum until a termination condition is obtained (e.g. a maximum number of iterations or a deviation parameter determined by the correlation function is smaller than a predetermined threshold value). A typical correlation function determines the quadratic deviation between the measured spectrum and the calculated intermediate spectrum.

Within the scope of the inventive optimization algorithm, convolution of the reference spectrum with a system function (“point spread function”) is applied as one of the individual steps (step c) in order to obtain a uniform line broadening with respect to the reference spectrum. A uniform line broadening of this type corresponds relatively precisely to the change of NMR lines (peaks in an NMR spectrum) of a substance that is dissolved in a liquid solvent. The line broadenings in infrared spectroscopy are uniform and caused by the instruments and can also be well imaged through the inventive convolution (in accordance with step c). The line broadening is described by a line parameter (e.g. full width at half maximum). For more complex system functions (in particular, composed system functions, e.g. a mixed Gaussian and Lorentz function), the line parameter may also be mufti-dimensional.

Further individual steps in the inventive optimization algorithm are position shift (step a) and amplitude adjustment (step b). The position change of the reference spectrum preferably also allows a shift by fractions of the point distance of the position variable, which leads to a particularly exact fit of the intermediate spectrum to the measured spectrum. The amplitude adjustment is typically performed in such a fashion that the maximum amplitude is selected for the position shift and line broadening selected in one iteration stage. With this amplitude, the intermediate spectrum remains everywhere (at all positions) just below or exactly at the measured spectrum, thereby preventing unrealistic fits.

The present invention is preferably used in NMR spectroscopy, in particular in one-dimensional NMR spectroscopy, wherein the measured spectrum is obtained from an FID signal of the sample through Fourier transformation. The position information in the spectrum is then a frequency, in most cases stated in ppm of a chemical shift. In optical spectroscopy (in particular IR spectroscopy) and X-ray spectroscopy, the position information is in most cases a wavelength. It should be noted that mufti-dimensional position variables can also be used within the scope of the invention (e.g. in the so-called 2-dimensional NMR spectroscopy).

The measured spectrum may be pre-processed prior to the start of the optimization algorithm, in particular, through base line correction or phase correction. The measured reference spectrum may also be pre-processed prior to the start of the optimization algorithm, in particular, for obtaining narrow spectral lines (peaks).

The invention realizes in a simple fashion a good fit of a best (resulting) intermediate spectrum to the measured spectrum of a sample and correspondingly permits simple determination of the signal portion of the substance in the measured spectrum. The concentration of the substance in the sample can then be easily calculated together with the signal portion of a calibration substance (which was added in a known concentration to the measured sample prior to measurement). It is also possible to perform a separate external calibration measurement and use it as a basis for determining the amount or concentration of the substance in the measured sample from the signal portion of the substance in the measured spectrum, in particular in accordance with the method known as PULCON, cf. G. Wider, L. Dreier, J. Am. Chem. Soc. 2006, No. 128, pages 2571-2576.

It should be noted that the substance generally only comprises one single type of molecule (including ionised molecule). It is, however, also possible to analyse a mixture of two or more types of molecules as a substance, in particular, when the different types of molecules of the substance have a fixed relative ratio with respect to one another. Typical substances to be determined in a sample are glucose, fructose, raw sugar, ethanol, methanol, glycol, creatine, creatinine, urea and lactic acid. Typical samples are fruit juice, wine, urine (in particular human urine), blood and blood plasma (in particular human blood and blood plasma). The invention is preferably used for the quality control of industrial processes, research (in particular medical research, preferably metabolomics) and medical diagnostics.

In a preferred variant of the inventive method, a discrete spectrum having the same resolution as the measured spectrum of the sample is used as a reference spectrum. A discrete reference spectrum is easy to handle and the fact that the resolutions are identical (the same distance between two position points in the two spectra, for NMR usually measured in ppm) facilitates pointwise shifting of the reference spectrum with respect to the measured spectrum without requiring interpolation for determining a deviation parameter. The latter may be utilized, in particular, in a chronologically first part of the optimization algorithm, in which rough adjustment to the measured spectrum is initially performed through shifting and amplitude adjustment, in most cases without line broadening. It should be noted that a measured spectrum is basically in discrete form.

In a preferred further development of this variant, the reference spectrum is determined from a previously measured reference spectrum having a different resolution than the measured spectrum of the sample and the intensity is determined through interpolation at least at a part of the positions in the reference spectrum. For this reason, one can simply revert to previous reference spectra, the resolution of which (distance between two position points) does not correspond to the measured spectrum of the sample. Interpolation may be carried out e.g. in the form of linear interpolation or also polynomial interpolation.

In another preferred further development, only the shift parameter and the amplitude factor are changed in a first part of the optimization algorithm. In a chronologically first part, rough adjustment (fitting) to the measured spectrum is initially performed through intermediate spectra, which does not yet require convolution. The omission of convolution correspondingly reduces calculation capacity and respectively accelerates the method. Convolution is not used until a chronologically later (in particular in the last) part of the optimization algorithm.

In a preferred method variant, the system function is a Lorentz function, a Gaussian function or a mixture of a Lorentz and a Gaussian function. These function types are comparatively simple to numerically handle and have proven to be practical for the method. They are moreover symmetrical which is preferred for the system function. The system function is alternatively an unsymmetrical function with respect to its central position, in particular, wherein the system function contains an imaginary part of a Lorentz function. The fit of the intermediate spectra to the measured spectrum of the sample can thereby be improved in the individual case, in particular for quantifying phase-sensitive 2D spectra.

In one particularly preferred method variant, the shift parameter comprises fractions of a resolution of the measured spectrum at least in a last part of the optimization algorithm. In the chronologically last part of the optimization algorithm, fine adjustment (fitting) of the intermediate spectrum to the measured spectrum of the sample can be performed. Shifting of the reference spectrum by fractions of resolution (i.e. non-integer multiples of the distance between two neighboring position points of the discrete spectrum) helps to improve the correspondence compared to limitation of fitting to integer point distances.

In a further development in this case, intensities of the intermediate spectra are advantageously determined through interpolation within the scope of the optimization algorithm. The intensity of the intermediate spectrum for the corresponding (fixed) positions of the measured spectrum of the sample can then be determined through interpolation when the intermediate spectrum has been shifted by a fraction of resolution with respect to the measured spectrum (or its discrete point positions). Linear interpolation or polynomial interpolation are preferably used.

In another preferred method variant, in at least a first part of the optimization algorithm, only amplitude factors are permitted with which the respective intermediate spectrum has, at each position, an intensity that is smaller or equal to the intensity of the measured spectrum at the respective position. This completely prevents unrealistic amplitude factors or adjustment parameters of the intermediate spectrum, and the determination of the concentration becomes more reliable. This admission condition is preferably used not only in a chronologically first part of the optimization method but during the overall optimization method.

In another likewise preferred alternative method variant, at least in a first part of the optimization algorithm, only amplitude factors are permitted with which the respective intermediate spectrum has, at each position, an intensity that exceeds the intensity of the measured spectrum at the respective position by maximally a threshold value GW. This also completely prevents unrealistic amplitude factors or adjustment parameters of the intermediate spectrum and the concentration determination becomes more reliable. The threshold value allows a slight excess of the measured spectrum as it may be obtained e.g. due to signal noise. The threshold value GW is correspondingly preferably selected to be of the order of magnitude of the typical amplitude of an observed noise of the reference spectrum or of the measured spectrum. This admission condition is preferably not only used in a chronologically first part of the optimization method but during the overall optimization method.

In one particularly preferred method variant, the recording of the reference spectrum is performed under the same measurement conditions as the recording of the measured spectrum of the sample. When the measurement conditions coincide, the inventive concentration determination is particularly reliable, since falsifications of the reference spectrum with respect to the signal portion of the measured spectrum are prevented by a deviating measurement condition, thereby preventing erroneous fitting. The coinciding measurement conditions comprise, in particular, the sample temperature and/or the solvent that is used in the sample and/or the strength of the static magnetic field during the respective measurement.

In another advantageous variant, the optimization algorithm applies the Marquardt-Levenberg algorithm. The Marquardt-Levenberg algorithm has proven itself in practice. It should be noted that other optimization methods can also be applied during one part of the optimization algorithm.

In another advantageous variant, the optimization method applies the simplex algorithm. The simplex algorithm has also proven itself in practice. It should be noted that other optimization methods can also be used during one part of the optimization algorithm.

In one particularly preferred method variant, the method is used in NMR (nuclear magnetic resonance) spectroscopy. In particular, the convolution of the reference spectrum with the system function in step c) facilitates fitting of line broadenings that are typical in NMR, which are due to solvents such as water or acetone, and the concentration can correspondingly be determined with particularly high accuracy.

In another method variant, the method is applied in optical spectroscopy, in particular IR (infrared) spectroscopy or X-ray spectroscopy or mass spectroscopy. In this case as well, the simple method steps can be easily applied without requiring an expert in spectral analysis.

In another advantageous method variant, the sample is a liquid sample or a solid sample, in particular, a powdery sample. With liquid samples, the line broadenings are particularly large, in particular, in NMR and can be well handled by the inventive method. The invention can also be easily used with solid samples.

The invention also concerns a spectroscopic apparatus, designed for automatically performing the inventive method, in particular, wherein the spectroscopic apparatus comprises a measurement unit for receiving the measured spectrum of the sample and/or the measured reference spectrum of the substance. The inventive method is particularly well suited to be established automatically. Towards this end, conventional computer systems can be provided with corresponding programming and suitable interfaces. Involvement of experts in spectroscopic analysis is basically not required, not even for the evaluation of a reference spectrum. It is therefore also possible for the user to measure new reference spectra and use them immediately in the inventive method. The spectroscopic apparatus is preferably designed not only for data evaluation but also for data recording.

Further advantages of the invention can be extracted from the description and the drawing. The features discussed above and below may be used in accordance with the invention either individually or collectively in arbitrary combination. The embodiments illustrated and described are not to be understood as an exhaustive enumeration, rather have exemplary character for describing the invention.

The invention is illustrated in the drawing and explained in more detail with reference to embodiments.

### BRIEF DESCRIPTION OF THE DRAWING

FIG. 1a shows a section of an experimental NMR spectrum of hippuric acid with marking of a partial range used for a reference spectrum within the scope of the invention; plotted to the right is the chemical shift in ppm and towards the top, the intensity;

FIG. 1b shows the reference spectrum resulting from FIG. 1; plotted to the right is the chemical shift in ppm and towards the top, the intensity;

FIG. 2 shows a section of an experimental NMR spectrum of a urine sample that can be used as a measured spectrum of a sample within the scope of the invention; plotted to the right is the chemical shift in ppm and towards the top, the intensity;

FIGS. 3a-3d each show the same section of the measured spectrum of FIG. 2 (single drawn line) and a reference spectrum of FIG. 1a (black highlighted line) which has been shifted to different extents and is amplitude-maximized;

FIG. 4 shows a section of the measured spectrum of FIG. 2 (single drawn line) and the reference spectrum of FIG. 1a (black highlighted line) that matches best and has been shifted by whole points and is amplitude-maximized;

FIG. 5 shows different forms of intermediate spectra B), C), D), E) which were produced from the reference spectrum A) through convolution with a Lorentz function with different full widths at half maximum in each case;

FIG. 6 shows a section of the measured spectrum of FIG. 2 (single drawn line) and the resulting intermediate spectrum, i.e. that corresponds best to the measured spectrum and was obtained from the reference spectrum of FIG. 1a through shifting, amplitude change and convolution with a Lorentz function in accordance with the invention;

FIG. 7 shows a Lorentz function (x values) and a Gaussian function (o values) which can be used as a system function within the scope of the invention; plotted to the right is the position (shown with full points) and towards the top, the functional value;

FIG. 8 shows a peak formed from discrete points and a peak obtained therefrom through polynomial interpolation and shifting by 0.5 points; and

FIG. 9 shows a schematic view of an inventive spectroscopic apparatus for automatic performance of the inventive method, comprising a measurement unit for recording spectra.

### DESCRIPTION OF THE PREFERRED EMBODIMENT

### Preferred Embodiment for the Inventive Fitting of a Reference Spectrum to a Measured Spectrum

The inventive method is described below with reference to an example, namely the determination of the concentration of hippuric acid in a urine sample through quantitative nuclear magnetic resonance analysis.

Hippuric acid is an organic compound that occurs in urine. The concentration of hippuric acid in the urine is used as an indicator for the diagnosis of certain congenital metabolic diseases. Certain therapeutic measures also change the concentration of hippuric acid in the urine.

Concentrations in the urine are mostly stated in relation to a known substance in the urine because of the varying dilution due to liquid consumption. A conventional substance of this type that is normally used is creatinine; the unit used is “mmol/mmol creatinine”. Creatinine occurs in the NMR spectrum in the form of one single peak which is quantified by fitting a Gaussian-Lorentz line to the experimental spectrum which does not need to be explained herein in more detail.

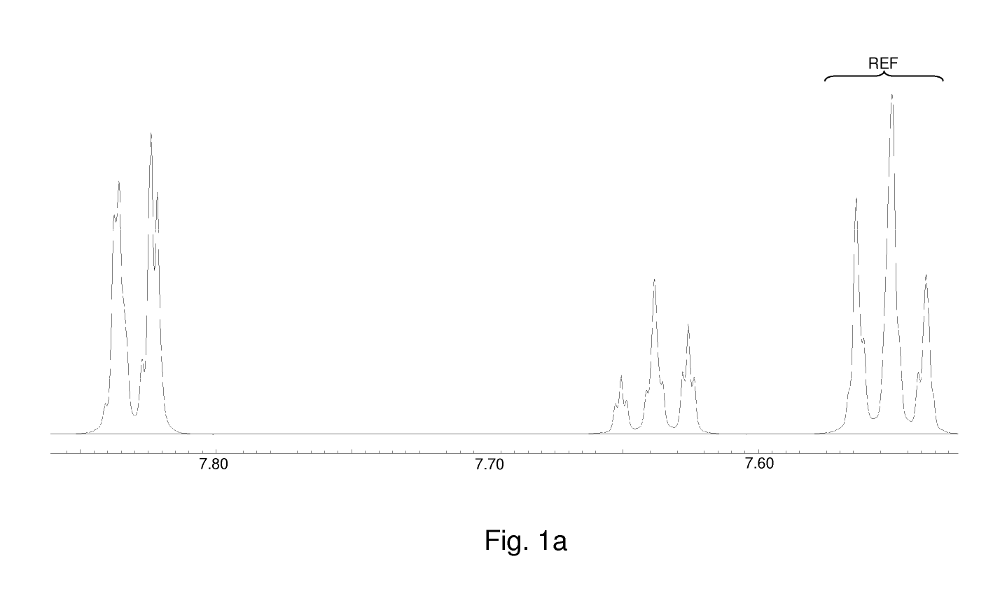

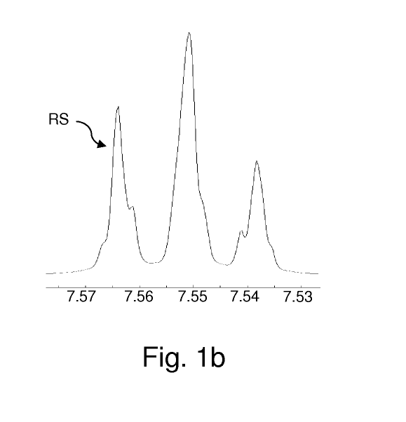

FIG. 1a shows a section of an experimental NMR spectrum of hippuric acid (in aqueous solution). It shows a complex spectrum, wherein the individual peaks are not separated from each other but are superimposed on each other. This section (or an even larger part of the experimental NMR spectrum of hippuric acid) could principally be used as a reference spectrum for the inventive method. In this example, however, only the frequency range (frequency interval) marked with REF is selected for the reference spectrum. This frequency range has five local maxima in this case, two of which are shown to be very small at the inner flanks of two outer large peaks. This frequency range is well suited for a quantitative analysis.

The experimental NMR spectrum shown in FIG. 1a has a resolution of 0.002 ppm (separation between two neighboring points, also called positions, at each of which one intensity value was detected).

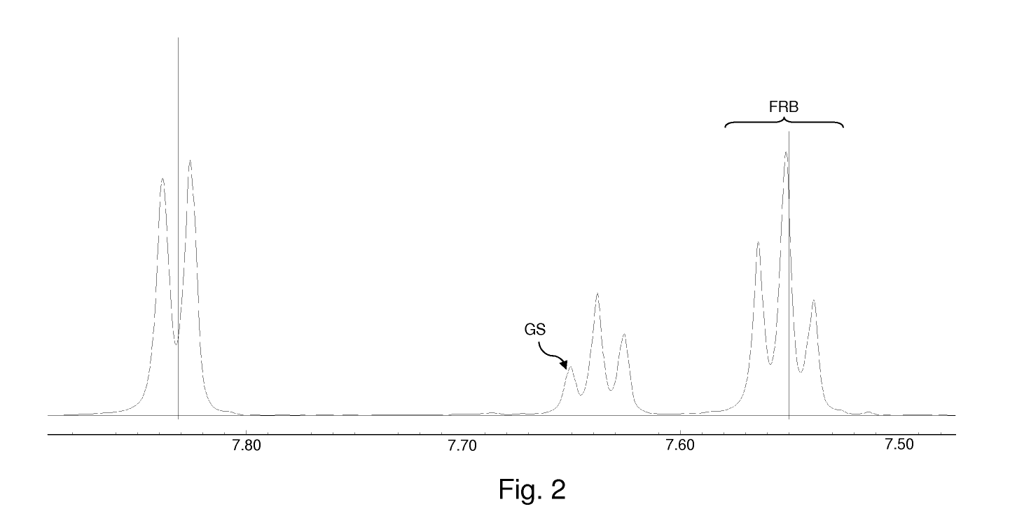

FIG. 2 shows a section of an experimental NMR spectrum of a urine sample in approximately the same frequency limits as in FIG. 1a. The urine sample contains hippuric acid such that peaks can be detected in the NMR spectrum of the urine at similar points as in the NMR spectrum of pure hippuric acid of FIG. 1a. Due to effects caused by the urine sample (i.e. its composition), the individual peaks in the urine spectrum are, however, broader than in the spectrum of pure hippuric acid of FIG. 1a. This applies, in particular, to the frequency range FRB selected for the reference spectrum. Only three local maxima can be detected in this case. The small maxima at the inner flanks of the two outer peaks can no longer be detected.

The NMR spectrum represented in FIG. 2, i.e. the measured spectrum GS of the (urine) sample, shall now be quantitatively evaluated, i.e. the concentration of hippuric acid (in relation to creatinine) shall be determined. Towards this end, the surface portion beneath the spectrum in the frequency range FRB that can be associated with hippuric acid, is determined. Only part of the surface beneath the spectrum of FIG. 2 in the frequency range FRB can be attributed to hippuric acid. Further substances in the urine increase the intensity in this frequency range FRB which may not be attributed to hippuric acid. For this purpose, the inventive method proposes to fit a reference spectrum of the substance to be determined, in the present case hippuric acid, through frequency shift, amplitude adjustment and convolution to the measured spectrum GS and subsequently determine the surface under the best matching fitted reference spectrum (here called resulting intermediate spectrum).

The resolution of the measured spectrum GS of the urine sample of FIG. 2 is 0.001 ppm in the present case. A reference spectrum is now used for preparing the further method steps. This is extracted from the section marked with REF in the spectrum of pure hippuric acid of FIG. 1a (“previous reference spectrum”), wherein, however, a further measurement point is calculated between two neighboring measurement points in each case through interpolation in order to thereby also obtain a resolution of 0.001 ppm in the reference spectrum. The reference spectrum RS calculated in this fashion is illustrated in FIG. 1b. It should be noted that in the illustrated spectra, in particular in FIGS. 1a, 1b, 2, the measurement points or calculated points are so close to each other that the individual points can no longer be detected individually.

In a chronologically first part of the inventive method, the reference spectrum RS is now roughly adjusted to the measured spectrum GS of the (urine) sample.

Towards this end, the reference spectrum RS is pointwise shifted (i.e. in steps of a resolution of 0.001 ppm in the present case) with respect to the measured spectrum GS and the amplitude of the reference spectrum is maximized in each case by a multiplied pre-factor (“amplitude factor”) such that the reference spectrum remains just below or at the measured spectrum GS at all frequency positions. For this reason, respective intermediate spectra ZW1 are obtained in this first part of the method.

A deviation function (also called correlation function or target function) is calculated for each of those intermediate spectra ZW1, which quantifies the deviation between the respective intermediate spectrum ZW1 and the measured spectrum GS. This deviation function is e.g. the sum of the quadratic deviations of the intensity values of the respective intermediate spectrum ZW1 from the intensity values of the measured spectrum GS at all frequency positions of the intermediate spectrum ZW1.

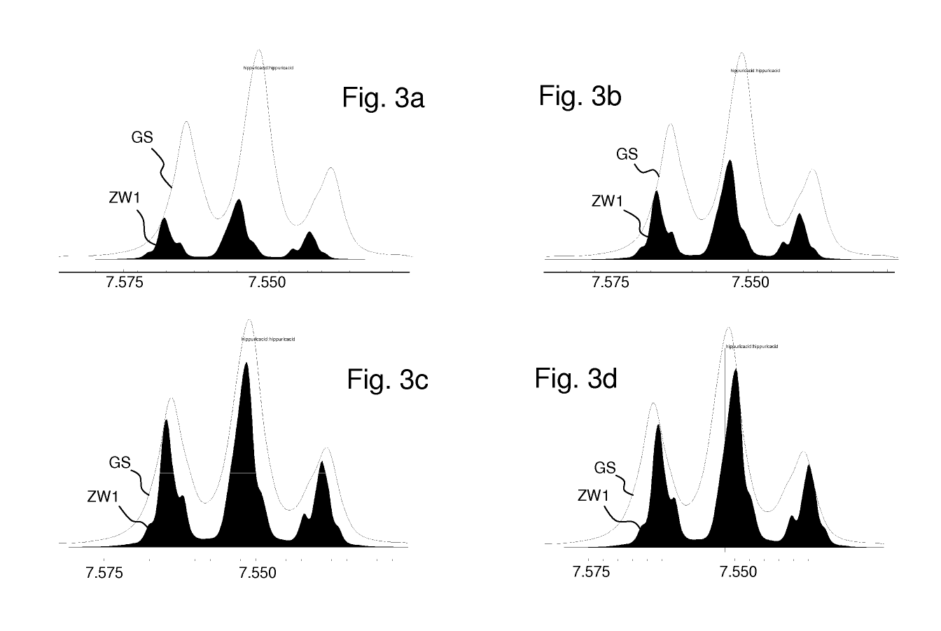

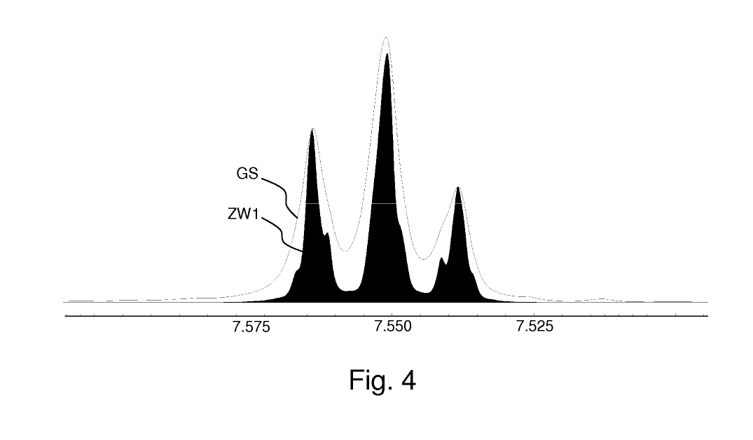

In this connection, FIGS. 3a through 3d respectively show the measured spectrum GS and intermediate spectra ZW1 that have been shifted to different extents. Within the scope of the first method part, all possible pointwise shifts can be calculated, which is preferred, or an optimization algorithm can already be applied that specifically selects and evaluates intermediate spectra with shift parameters resulting from the algorithm (amounts of frequency shift). FIG. 4 shows the best intermediate spectrum ZW1 which has a minimum deviation from the measured spectrum GS and which is obtained from the reference spectrum RS by frequency shift through whole points and amplitude maximization under the measured spectrum GS.

This is followed by a second part of the inventive method, in which fine adjustment of the reference spectrum to the measured spectrum is performed.

In the chronologically second part of the method, intermediate spectra ZW2 are calculated from the reference spectrum RS in each case, which includes both shifting of the reference spectrum by fractions of the resolution and also convolution of the reference spectrum with a system function, as well as adjustment of the amplitude of the reference spectrum (and preferably maximization thereof beneath the measured spectrum GS).

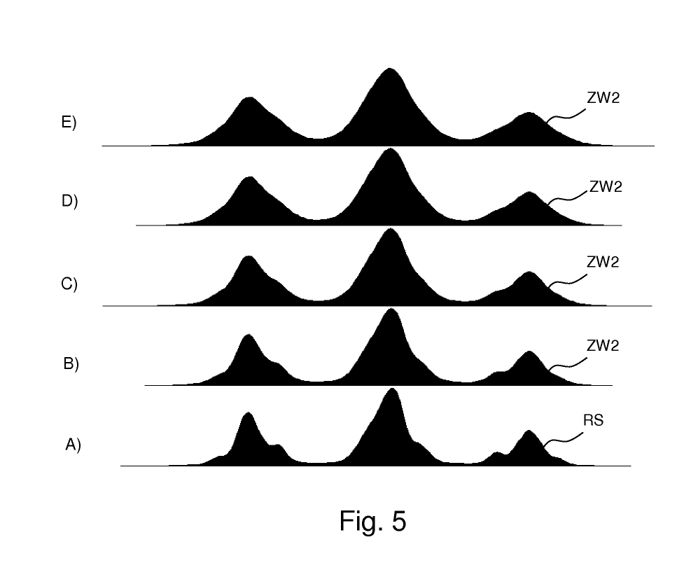

FIG. 5 illustrates the line broadening obtained from the reference spectrum RS through convolution with a Lorentz function as a system function. The line broadening can be adjusted using the full width at half maximum (FWHM) of the applied Lorentz function. The following was applied: full width at half maximum A)=0 points, coinciding with the reference spectrum RS, B) 1 point, C) 2 points, D) 3 points, E) 3.8 points. FIG. 5 clearly shows that starting from the intermediate spectrum ZW2 at C), the intermediate spectra ZW2 have only three local maxima similar to the spectrum of the urine sample in the observed frequency range FRB in FIG. 2.

A suitable optimization algorithm, e.g. a simplex algorithm, then determines that intermediate spectrum ZW2, which yields maximum coincidence with the measured spectrum GS. Towards this end, a large number of intermediate spectra ZW2 are iteratively calculated, in which different shift parameters (i.e. amounts of frequency shift), line broadening parameters (in the present case full widths at half maximum of the Lorentz function as a system function) and amplitude factors (in the present case maximized such that the respective intermediate spectrum ZW2 remains at all positions just below or at the measured spectrum GS) are applied. The above-mentioned deviation function is again calculated for each intermediate spectrum ZW2 in order to quantify the deviation from the measured spectrum GS. The deviation value is iteratively minimized.

The optimization algorithm starts with the shift parameter and the amplitude factor that has turned out to be the best at the end of the first part of the method (compare intermediate spectrum ZW1 in FIG. 4). Through admission of fractional shifts and performance of convolution, the correspondence between the intermediate spectra ZW2 and the measured spectrum GS can then be considerably improved compared to the first part of the method.

The optimization algorithm is terminated by a suitable termination condition. A maximum number of iterations or falling below a threshold value for the value of the deviation function are typical termination conditions. It is also possible to terminate the optimization algorithm when the improvement of the value of the deviation function falls below a threshold value throughout a predetermined number of iterations.

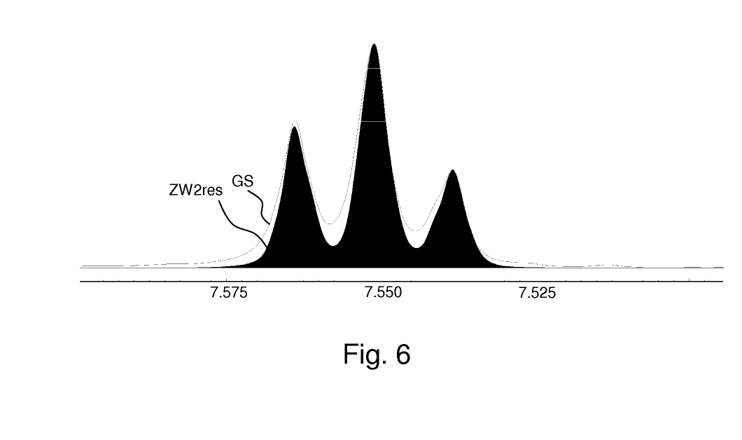

FIG. 6 shows the resulting best matching intermediate spectrum ZW2res and as a comparison the measured spectrum GS of the (urine) sample. The concentration of the hippuric acid in the urine sample can be quantified (under application of normal calibration) by means of the surface below the fitted resulting intermediate spectrum ZW2res, illustrated in black in FIG. 6.

If the concentration of hippuric acid is determined by means of the intermediate spectrum ZW1 obtained according to the first part of the method (cf. FIG. 4), the concentration of hippuric acid would be significantly underestimated in comparison with the determination of the concentration using the resulting intermediate spectrum ZW2res obtained according to the second part of the method. In the illustrated example, the result of the examined urine sample using the intermediate spectrum ZW1 of FIG. 4 would give a concentration of 27 mmol hippuric acid per mmol creatinine, whereas the resulting intermediate spectrum ZW2res of FIG. 6 would give a concentration of 40 mmol hippuric acid per mmol creatinine.

### System Functions

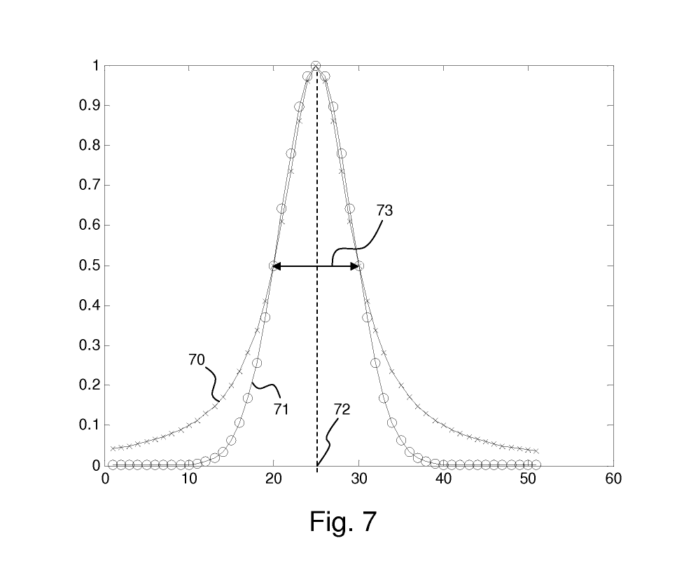

FIG. 7 shows a Lorentz function 70 (marked with x values) and a Gaussian function 71 (marked with o values) which can be used as system functions within the scope of the invention. It is also possible to use a mixture of both function types (i.e. a Lorentz function multiplied by a Gaussian function). In the above example, a Lorentz function is convoluted with the reference spectrum in the second part of the inventive method.

Convolution of the reference spectrum with a system function yields a line broadening in the intermediate spectrum in comparison with the reference spectrum. In particular, when a Lorentz function 70 is used, the line broadening that often occurs in NMR spectra due to solvent can be very well approximated or fitted.

In the example illustrated in FIG. 7, each system function is described at discrete (full) points. Each system function 70, 71 is characterized by a center position 72, a full width at half maximum 73 and a maximum value (in the present case normed to 1). In the illustrated example, the full width at half maximum 73 for both system functions is 10 points in each case, and the center position 72 is at the point value 25 in each case.

Interpolation with Fractional Shifts

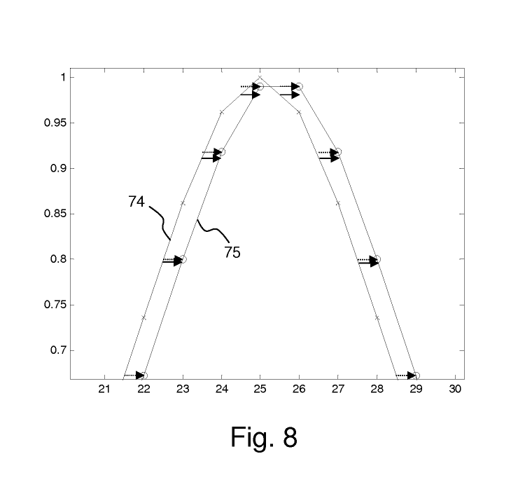

FIG. 8 shows (with x values) the tip of a discrete Lorentz curve 74 as an example for a discrete spectrum that is to be shifted by a fraction of the resolution, in the present case e.g. by half a point. Corresponding operations are performed with the reference spectrum in the above example in the second part of the inventive method. Within the scope of the invention, fractional shifts are typically permitted in steps of tenths of points or even smaller point fractions. It is also possible by means of the optimization algorithm to permit nearly continuous shifts smaller than a one point distance in accordance with the real numbers that can be numerically processed by the optimization algorithm.

Towards this end, intermediate values of the discrete Lorentz curve 74 must be initially determined, in the present case at the half-point positions. This can be realized in the simplest fashion through linear interpolation. In the present case, the average value between the intensity values of the two neighboring (measured) points is determined for this purpose, cf. in each case the rear end of the solid arrows. This point value is then displaced by the desired shift, in the present case half a point, cf. front tip of the solid arrows. This procedure is very simple but slightly falsifies the curve to be shifted close to a maximum.

Interpolation can be improved by using polynomial interpolation. In this case, a polynomial (at least of second, preferably at least third order) is thereby placed through some points around the searched half point position and the function value of the polynomial is determined at the desired half point position (cf. in each case the rear end of the dotted arrows) and displaced by the desired shift (cf. front tip of the dotted arrows in FIG. 8). A polynomial of third order may e.g. be placed through two points before and two points after the desired half point position. By means of this polynomial interpolation, one can obtain, from the discrete points of the Lorentz curve 74, the discrete curve 75 (with o values) shifted by half a point in FIG. 8, the curve 75 having a center position of 25.5. The improvement of the accuracy obtained through polynomial interpolation in comparison with linear interpolation is illustrated by the different positions of the solid arrows and the dotted arrows, in particular, close to the maximum.

### Spectroscopic Apparatus

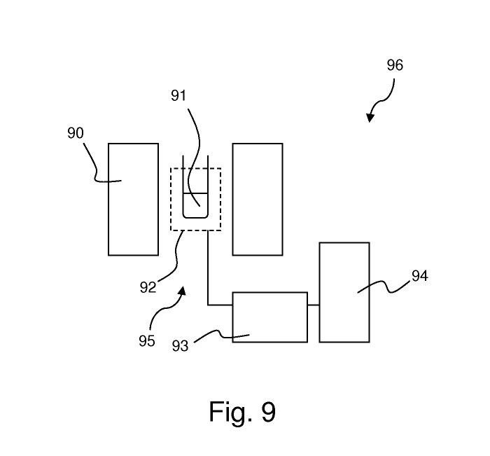

FIG. 9 schematically shows an inventive spectroscopic apparatus 96 by means of which the inventive method for determining the concentration can be performed, in the present case on the basis of NMR spectra.

In this case, the spectroscopic apparatus 96 comprises a measurement unit 95 for recording experimental NMR spectra, in particular reference spectra of substances to be quantitatively determined (typically in pure form or in the form of a single substance dissolved in a pure solvent) and spectra of samples to be examined. In the embodiment illustrated, the measurement unit 95 has a magnet 90 (e.g. a superconducting magnet in a cryostat) in the sample volume of which a homogeneous magnetic field Bo is generated. Samples 91 to be investigated, in the present case a liquid sample 91 in a sample tube, are arranged in this sample volume and irradiated with radio frequency pulses via an RF resonator 92. The radio frequency response of the sample 91 is also received by the RF resonator 92 (“combined resonator”). A combined RF generator and RF receiver 93 is connected to the RF resonator 92.

The spectroscopic apparatus 96 moreover has an evaluation unit 94. It can generate NMR spectra from the signals passed on by the RF generator 93 by means of Fourier transformation. The evaluation unit 94 can furthermore automatically fit stored measured reference spectra of substances to be quantitatively determined to a measured spectrum of a sample (which can also be stored) in accordance with the inventive method through suitable programming. From the reference spectrum that belongs to the respective substance and has been fitted through frequency shift, convolution and amplitude adjustment, it is possible to automatically determine the signal portion in the measured spectrum that belongs to the substance, from which, in turn, the concentration of that substance in the sample can be automatically calculated and output.

I claim:

1. A method for determining a concentration of a substance in a sample or in a liquid sample, wherein a signal portion that can be attributed to the substance is determined in a measured sample spectrum that gives an intensity as a function of a position, wherein a plurality of intermediate spectra is calculated in each case from a measured reference spectrum of the substance until a predetermined correlation between a resulting intermediate spectrum and the measured spectrum is obtained, the signal portion being calculated through integration of a resulting intermediate spectrum fitted to the measured spectrum, wherein the method comprises the following steps which are applied to the reference spectrum in order to calculate the intermediate spectra:
a) shifting a position in accordance with a shift parameter;
b) multiplying with an amplitude factor; and
c) convoluting with a system function in accordance with a line broadening parameter, wherein the shift parameter, the amplitude factor and the line broadening parameter are changed within the scope of an optimization algorithm that iteratively optimizes a correspondence between the intermediate spectra and the measured spectrum.

2. The method of claim 1, wherein a discrete spectrum that has a same resolution as the measured spectrum of the sample is used as the reference spectrum.

3. The method of claim 2, wherein the reference spectrum is determined from a measured previous reference spectrum having a different resolution than the measured spectrum of the sample and an intensity is determined at least at a part of positions in the reference spectrum through interpolation.

4. The method of claim 2, wherein only the shift parameter and the amplitude factor are changed in a first part of the optimization algorithm.

5. The method of claim 1, wherein the system function is a Lorentz function, a Gaussian function or a mixture of a Lorentz and a Gaussian function.

6. The method of claim 1, wherein the shift parameter comprises fractions of a resolution of the measured spectrum, at least in a last part of the optimization algorithm.

7. The method of claim 6, wherein intensities of the intermediate spectra are determined through interpolation within a scope of the optimization algorithm.

8. The method of claim 1, wherein in at least a first part of the optimization algorithm, only amplitude factors are permitted with which a respective intermediate spectrum, at each position, has an intensity that is smaller or equal to an intensity of the measured spectrum at a respective position.

9. The method of claim 1, wherein at least in a first part of the optimization algorithm, only amplitude factors are permitted with which the respective intermediate spectrum has, at each position, an intensity that exceeds an intensity of the measured spectrum at a respective position by maximally a threshold value.

10. The method of claim 1, wherein a recording of the reference spectrum is performed under same measurement conditions as a recording of the measured spectrum of the sample.

11. The method of claim 1, wherein the optimization algorithm applies a Marquardt-Levenberg algorithm.

12. The method of claim 1, wherein an optimization method applies a simplex algorithm.

13. The method of claim 1, wherein the method is used in NMR (nuclear magnetic resonance) spectroscopy.

14. The method of claim 1, wherein the method is applied in optical spectroscopy, in IR (infrared) spectroscopy, in X-ray spectroscopy or in mass spectroscopy.

15. The method of claim 1, wherein the sample is a liquid sample, a solid sample or a powdery sample.

16. A spectroscopic apparatus designed for automatically performing the method of claim 1.

17. The apparatus of claim 16, wherein the spectroscopic apparatus comprises a measurement unit for receiving the measured spectrum of the sample and/or the measured reference spectrum of the substance.
